(19) United States
(12) Patent Application Publication
(10) Pub. No.: US 2002/0170234 A1
(43) Pub. Date: Nov. 21, 2002

(54) Guide device for folding door

(76) Inventor: Luciano Salice, Carimate (IT)

Correspondence Address: Jeffrey S. Steen, CARTER, DELUCA, FARRELL & SCHMIDT, LLP, Suite 225, 445 Broad Hollow Road, Melville, NY, 11747, US

(21) Appl. No.: 10/146,352

(22) Filed: May 15, 2002

(30) Foreign Application Priority Data
May 16, 2001 (DE) 201 08 229.2

(51) Int. Cl. E05D 13/00

(52) U.S. Cl. 49/453; 49/409

(57) ABSTRACT

A guide device for a folding door consisting of a carriage which is displaceably guided at a web part of a section rail and which surrounds the web part with rollers or slides. So that the guide device can easily be put into its longitudinally displaceable connection with the web part of the section rail from the side, the rear roller disposed behind the web part relative to the door is supported at an arm which is in pivoted connection with the carriage and which can be pivoted between an assembly position where it is pivoted out and a position of use where it is pivoted in, in which the rear roller contacts or almost contacts the front side of the web part.

The invention relates to a guide device for a folding door consisting of a carriage which is displaceably guided at a web part of a section rail and which surrounds the web part with rollers or slides.

Guide devices for folding doors are guided in longitudinally displaceable manner in section rails secured to the top and/or base panels of furniture parallel to their side edges bounding the openings, without also being movable transversely thereto. To also be able to put a guide device secured to a leaf at a folding door into displaceable connection with a section rail when the inner door leaf is already linked to a body wall of a part of a piece of furniture, it is desirable to be able to put the guide device into displaceable connection with the section rail during the assembly of the folding door by a movement transverse to said section rail in order not to have to insert the guide device onto or into the section rail by the ends.

A guide device of the kind first mentioned is known from DE 297 01 260 U1 in which the rear roller is movably supported at the carriage such that it can be displaced perpendicular to the displacement plane of the carriage from a position above a section rail secured to the base of a part of a piece of furniture into a position in which it engages behind the rear of the web part, with the vertically displaceable axle of the roller having two latch grooves into which a snapper provided at the carriage latches optionally in the moved-in position of use or in the moved-out assembly position. With the known guide device, difficulties arise when the roller abuts the end face of the web part on its displacement from the assembly position into the position of use.

It is the object of the invention to provide a guide device of the kind first mentioned which can easily be put into its longitudinally displaceable connection with the web part of the section rail from the side.

This object is solved in accordance with the invention in that the rear roller disposed behind the web part relative to the door is supported at an arm which is in pivoted connection with the carriage and which can be pivoted between an assembly position where it is pivoted out and a position of use where it is pivoted in, in which the rear roller contacts or almost contacts the rear side of the web part.

The guide device in accordance with the invention can easily be moved into its longitudinally displaceable position of use at the web part of the section rail in that the rear roller supported at the pivotable arm is pivoted in pincer-like manner toward the web part, with an abutting at the end face or at edges of the section rail which would hinder assembly is precluded.

The guide device in accordance with the invention can be put into longitudinally displaceable connection with a section rail at the base side. To also be able to put the guide device in accordance with the invention in longitudinally displaceable connection with a section rail at the top side, at which it is guided in a manner such that it can also carry a door leaf in a suspended manner, it is provided in another aspect of the invention that the web part of a section rail to be secured to a top of a piece of furniture is provided at its lower end with a bend which points to the door and on whose upper running surface the carriage is supported by a roller or a slide. A roller running on the bend of the web part is expediently supported on the carriage rotatably about a horizontal axis.

The carriage is expediently provided with at least one runner which is supported on a vertical axle and which runs off on the front side of the web part.

In accordance with another aspect of the invention, it is provided that the pivotal arm is latchable to the carriage in a position where it is pivoted in. The pivotal arm is preferably also latchable to the carriage in its assembly position where it is pivoted out.

In accordance with a particularly advantageous aspect, it is provided that the arm is displaceably supported on a bolt secured at side parts of the carriage which are parallel to one another and is provided at one side with a spigot which engages in the positions of the arm where it is pivoted in and where it is pivoted out in bores of the side part facing it and that a compression spring is clamped between the other side part and the arm and loads the arm in the direction of the bores.

In accordance with another embodiment, the pivotal arm can also be provided with a laterally displaceable pin. In this embodiment, only the latch pin is displaceable and not the whole arm. The pivotal arm is expediently provided with an actuating device to displace the pin. The latch pin can also be able to be pressed in against the force of a spring.

The pivotal arm expediently has a U-shaped section in longitudinal section, with the roller being supported on a journal which is connected to the web part of the section.

The carriage is provided with a device for securing a hinge arm, e.g. the hinge arm of a dual-link hinge, for connection with a leaf of the folding door.

An embodiment of the invention will be described in more detail in the following with reference to the drawing. There are shown in this:

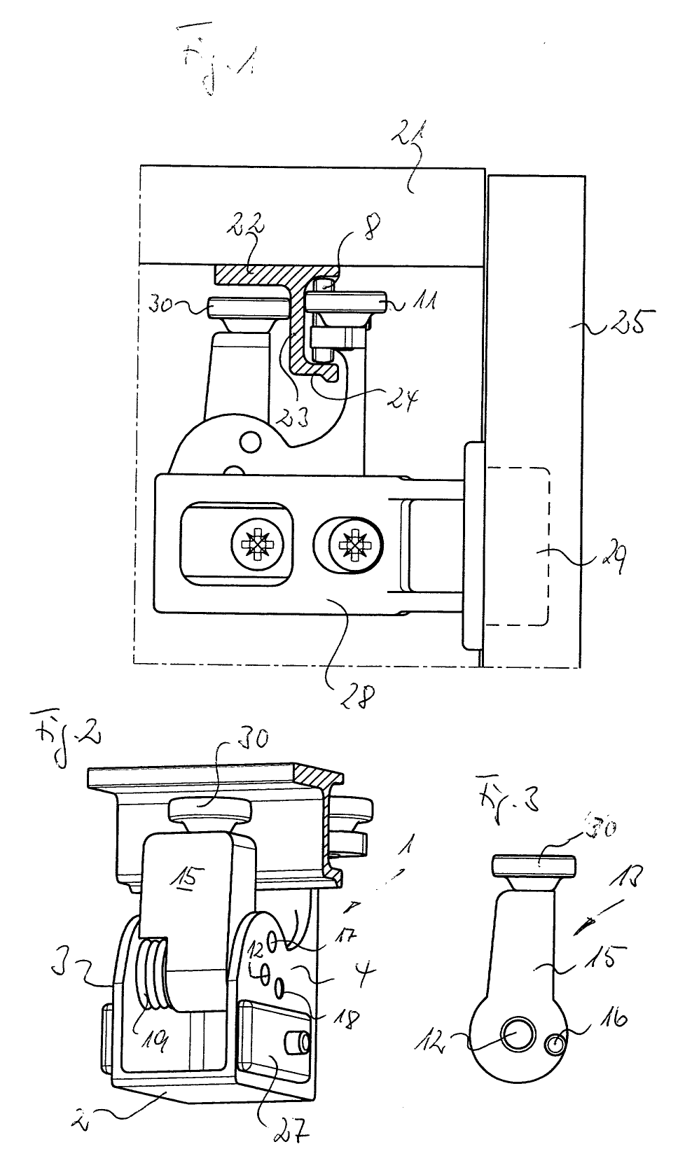

FIG. 1 a side view of the guide device which is guided at the web part of a section connected to the top of a piece of furniture and is connected to a leaf of a folding door by a dual-link hinge;

FIG. 2 a perspective view of the guide device in accordance with FIG. 1;

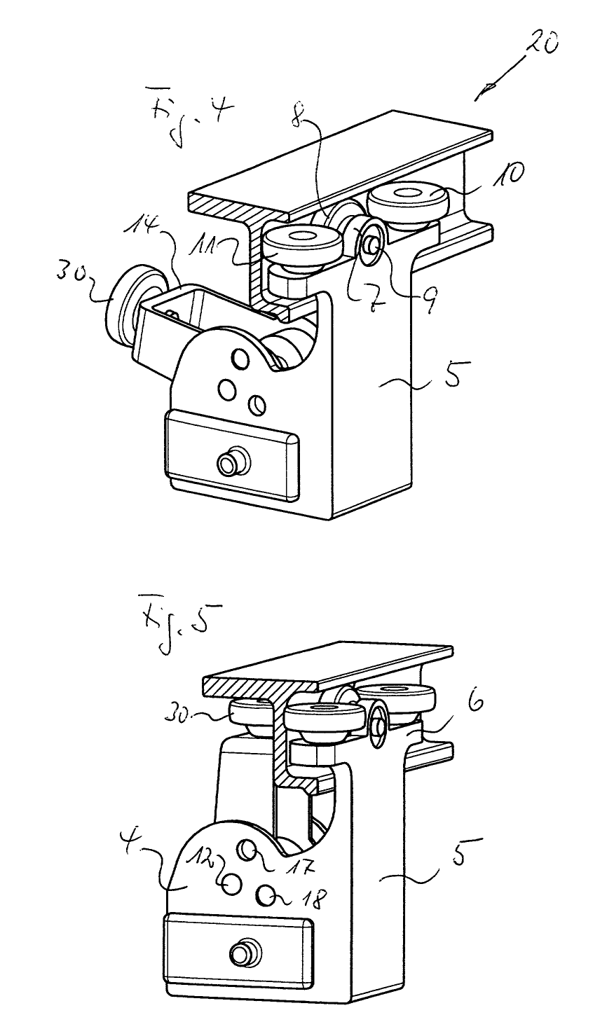

FIG. 3 a side view of the pivotal arm carrying a roller;

FIG. 4 a perspective view of the guide device in its assembly position in which the arm carrying a roller is pivoted out; and

FIG. 5 a perspective view of the guide device in its position of use in which it is longitudinally displaceably guided at the web part of the section rail.

The guide device consists of a carriage 1 with a housing-like base body which has a base 2, side parts 3, 4 connected to this and parallel to one another and a rear wall 5 which carries a widened transverse member 6 at its upper end. The transverse member 6 is provided in its central region with a bead 7 which is approximately arc-like in shape and which has a bore which extends parallel to the base 2 and transversely to the transverse member 6 and in which a journal 9 carrying a roller 8 is held. The side leaf parts of the transverse member 6 are provided at their upper side parallel to the base 2, at both sides of the bead 7, with journals which stand at right angles to it and on which rollers 10, 11 are rotatably mounted. An arm 13, which has an approximately U-shaped section in transverse and longitudinal section, is pivotably mounted on an axle 12 which consists of a bolt and which is held in bores of the side parts 3, 4 of the base body. An upwardly projecting journal, on which a roller 30 is rotatably mounted, is secured at the web part 14 of the arm 13 opposite the pivot axle 12. The arm 13 is guided displaceably on the axle 12 and has a latch spigot 16 at its side 15 facing the side wall 4 and spaced from the axle 12, said latch spigot 16 being latchable in bores 17, 18 of the side part 4. The axle 12 passes through a compression spring 19 which is clamped between the side wall 3 of the base body and the side of the arm which is opposite the side of the arm carrying the latch spigot 16. The bores 17, 18 in the side wall 4 are arranged such that the latch spigot 16 is latched in the assembly position visible from FIG. 4 in the bore 17 and in the position of use visible from FIG. 5 in the bore 18. To latch the latch spigot 16 in the one or the other bore 17, 18, it is only necessary to displace the arm 13 against the force of the spring 19 such that the latch spigot 16 comes out of engagement with a bore and can then be latched in the desired bore by a corresponding pivoting of the arm.

The guide device is longitudinally displaced at a guide rail 20 which is secured near to the opening and parallel to the opening rim of the top 21 of a part of a piece of furniture. The section rail consists of a strip 22 which serves the securing and which is provided with a web part 23 standing at right angles on it. The web part 23 is provided at its free end with a right angled bending 24 which forms an upper running surface for the roller 8. In the position of use visible from FIGS. 1, 2 and 5, the rollers 10, 11 and 30 run on opposite sides of the web part 23, while the roller 8, which runs on the running surface of the bending 24, carries the door leaf 25 in a suspended manner.

Pedestal-like elevations 27 are connected to the side parts 3, 4 for left hand or right hand assembly and serve the securing of hinge arms 28, for example of dual-link hinges, whose hinge cups 29 are connected in conventional manner to the door leaf 25.

The section rail 20 expediently consists of an extruded section, while the base body 1 and the pivotable arm 15 can be made of metal die cast parts.

1. A guide device for a folding door consisting of a carriage (1) which is displaceably guided at a web part (23) of a section rail (20) and which surrounds the web part (23) with rollers (10, 11, 30) or slides,
characterised in that
the rear roller (30) located behind the web part (23) relative to the door (25) is supported at an arm (13) which is pivotably connected to the carriage (1) and which can be pivoted between its assembly position where it is pivoted out (FIG. 4) and a position of use where it is pivoted in (FIG. 1), in which the rear roller (30) contacts or almost contacts the rear side of the web part (23).

2. A guide device in accordance with claim 1, wherein the web part of the section rail (20) to be secured to the top (21) of a piece of furniture is provided at its lower end with a bend (24) which points to the door (25) and on whose upper running surface the carriage (1) is supported with a roller (8) or a slide.

3. A guide device in accordance with either of claim 1 or 2, wherein the carriage (1) is provided with at least one roller (10, 11) which is supported on a vertical axle and which rolls off on the front side of the web part (23).

4. A guide device in accordance with any of claims 1 to 3, wherein the pivotal arm (13) can be latched to the carriage (1) in its position of use where it is pivoted in.

5. A guide device in accordance with any of claims 1 to 4, wherein the pivotal arm (13) can be latched to the carriage (1) in its assembly position where it is pivoted out.

6. A guide device in accordance with any of claims 1 to 5, wherein the arm (13) is displaceably supported on a bolt (12) secured to sides parts (3, 4) of the carriage (1) parallel to one another and is provided at one side with a spigot (16) which, in the position of the arm (13) pivoted out and pivoted in, engages in bores (17, 18) of the side part (4) facing it, and wherein a compression spring (19), which loads the arm (13) in the direction of the bores (17, 18), is clamped between the other side part (3) and the arm (13).

7. A guide device in accordance with any of claims 1 to 6, wherein the pivotal arm (13) is provided with a laterally displaceable latch pin.

8. A guide device in accordance with claim 7, wherein the pivotal arm is provided with an actuation device to displace the latch pin.

9. A guide device in accordance with either of claim 7 or 8, wherein the latch pin can be pressed in against the force of a spring.

10. A guide device in accordance with any of claims 1 to 9, wherein the pivotal arm (13) has a U-shaped profile in cross-section.

11. A guide device in accordance with any of claims 1 to 10, wherein the carriage (11) is provided with a device (27) to secure a hinge arm (28), for example the hinge arm of a dual-link hinge.
